(19) United States
(12) Patent Application Publication
(10) Pub. No.: US 2024/0303150 A1
(43) Pub. Date: Sep. 12, 2024

(54) METHODS AND APPARATUS TO IMPROVE AVAILABILITY OF FAILED ENTITIES

(71) Applicant: VMware LLC, Palo Alto, CA (US)

(72) Inventors: Devang Dipakbhai Pandya, Bangalore (IN); Krishnamoorthy Balaraman, Bangalore (IN); Rahul Kumar Singh, Bangalore (IN); Gopal Krishna Goalla, Bangalore (IN)

(21) Appl. No.: 18/181,360

(22) Filed: Mar. 9, 2023

(51) Int. Cl. G06F 11/07; G06F 9/50

(52) U.S. Cl. CPC G06F 11/0793; G06F 9/5077; G06F 11/0721

(57) ABSTRACT

An apparatus disclosed herein includes memory; computer readable instructions; and programmable circuitry to be programmed by the computer readable instructions to: generate a reclamation recommendation based on a subset of entities eligible for reclamation, the subset of the entities meeting a resource requirement of a failed entity; reconfigure the subset of the entities to reclaim resources of the subset of the entities based on the reclamation recommendation; and execute the failed entity using the reclaimed resources of the subset of the entities.

### FIELD OF THE DISCLOSURE

This disclosure relates generally to computing environments, and, more particularly, to methods and apparatus to improve availability of failed entities.

### BACKGROUND

Computing environments often include many virtual and physical computing resources. For example, software-defined data centers (SDDCs) are data center facilities in which many or all elements of a computing infrastructure (e.g., networking, storage, CPU, etc.) are virtualized and delivered as a service. The computing environments often include management resources for facilitating management of the computing environments and the computing resources included in the computing environments. Some of these management resources include the capability to automatically monitor computing resources and generate alerts when compute issues are identified. Additionally or alternatively, the management resources may be configured to provide recommendations for responding to generated alerts. In such examples, the management resources may identify computing resources experiencing issues and/or malfunctions and may identify methods or approaches for remediating the issues. Recommendations may provide an end user(s) (e.g., an administrator of the computing environment) with a list of instructions or a series of steps that the end user(s) can manually perform on a computing resource(s) to resolve the issue(s). Although the management resources may provide recommendations, the end user(s) may be responsible for implementing suggested changes and/or performing suggested methods to resolve the compute issues.

### BRIEF DESCRIPTION OF THE DRAWINGS

FIG. 1 is a block diagram of an example environment in which example entity management circuitry is configured to improve availability of failed entities.

FIG. 2 is a block diagram of an example implementation of the example entity management circuitry of FIG. 1.

FIG. 3 illustrates a flowchart representative of example machine readable instructions that may be executed by example processor circuitry to implement the example entity management circuitry of FIG. 1 and/or FIG. 2 to reclaim resource(s) after a failure.

FIG. 4 illustrates a flowchart representative of example machine readable instructions that may be executed by example processor circuitry to implement the example entity management circuitry of FIG. 1 and/or 2 to create a candidate set of entities eligible for reclamation.

FIG. 4 illustrates a flowchart representative of example machine readable instructions that may be executed by example processor circuitry to implement the example entity management circuitry of FIG. 1 and/or 2 to create a candidate set of entities eligible for reclamation.

FIGS. 5A-5B illustrate a flowchart representative of example machine readable instructions that may be executed by example processor circuitry to implement the example entity management circuitry of FIG. 1 and/or 2 to filter candidate set of entities to meet resource requirements of a failed entity to generate a reclamation recommendation.

FIG. 6 illustrates a flowchart representative of example machine readable instructions that may be executed by example processor circuitry to implement the example entity management circuitry of FIG. 1 and/or FIG. 2 to execute a reclamation recommendation.

FIG. 7 is a block diagram of an example processor platform including processor circuitry structured to execute the example machine readable instructions of FIGS. 3-6 to implement the example entity management circuitry of FIGS. 1 and/or 2.

FIG. 8 is a block diagram of an example implementation of the processor circuitry of FIG. 7.

FIG. 9 is a block diagram of another example implementation of the processor circuitry of FIG. 7.

FIG. 10 is a block diagram of an example software distribution platform (e.g., one or more servers) to distribute software (e.g., software corresponding to the example machine readable instructions of FIGS. 3-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

### DETAILED DESCRIPTION

The figures are not to scale. Instead, the thickness of the layers or regions may be enlarged in the drawings. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time +/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

Virtual computing services enable one or more assets to be hosted within a computing environment. As disclosed herein, an asset is a computing resource (physical or virtual) that may host a wide variety of different applications such as, for example, an email server, a database server, a file server, a web server, etc. Example assets include physical hosts (e.g., non-virtual computing resources such as servers, processors, computers, etc.), virtual machines, containers that run on top of a host operating system without the need for a hypervisor or separate operating system, hypervisor kernel network interface modules, etc. In some examples, an asset may be referred to as a compute node, an end-point, a data computer end-node or as an addressable node.

Virtual machines operate with their own guest operating system on a host (e.g., a host server) using resource(s) of the host virtualized by virtualization software (e.g., a hypervisor, virtual machine monitor, etc.). Numerous virtual machines can run on a single computer or processor system in a logically separated environment (e.g., separated from one another). A virtual machine can execute instances of applications and/or programs separate from application and/or program instances executed by other virtual machines on the same computer.

Management applications (e.g., cloud management such as vSphere® Automation Cloud Assembly) provide administrators the ability to manage and/or adjust of assets and/or entities (e.g., virtualized resources, virtual machines, containers, processes, etc.) in a computing environment. As used herein, an entity is a virtual machine, a virtualized resource, one or more memory resources, one or more processor resources, a container, a process, and/or any other resource. Administrators can inspect the assets, see the organizational relationships of a virtual application, filter log files, overlay events versus time, etc. In some examples, an application may install one or more plugins (sometimes referred to herein as “agents”) at the asset to perform monitoring operations. For example, a first management application may install a first monitoring agent at an asset to track an inventory of physical resource(s) and logical resource(s) in a computing environment, a second management application may install a second monitoring agent at the asset to provide real-time log management of events, analytics, etc., and a third management application may install a third monitoring agent to provide operational views of trends, thresholds and/or analytics of the asset, etc. However, executing the different monitoring agents at the asset consumes resources (e.g., physical resources) allocated to the asset. In addition, some monitoring agents may perform one or more similar task(s).

In some systems (e.g., such as vRealize® Automation), a user and/or administrator may set up and/or create a cloud account (e.g., a Google® cloud platform (GCP) account, a network security virtualization platform (NSX) account, a VMware® cloud foundation (VCF) account, a vSphere® account, etc.) to connect a cloud provider and/or a private cloud so that the management applications can collect data from regions of datacenters. Additionally, cloud accounts allow a user and/or administrator to deploy and/or provision cloud templates to the regions. A cloud template is a file that defines a set of resources. The cloud template may utilize tools to create server builds that can become standards for cloud applications. A user and/or administrator can create cloud accounts for projects in which other users (e.g., team members) work. The management applications periodically perform health checks on the cloud accounts to verify that the accounts are healthy (e.g., the credentials are valid, the connectivity is acceptable, the account is accessible, etc.). Such systems may also include a cloud computing virtualization platform and/or management circuitry (e.g., such as vSphere® and/or vSphere® high availability) to control virtualized resource(s) (e.g., by moving virtual machines and/or other virtualized entities from one host to another) to ensure that there are sufficient virtualized resource(s) to perform one or more operations. For example, the cloud computing virtualization platform provides high availability for virtual machines and/or other virtualized entities. High availability (HA), in the context of cluster-based computing (e.g., where a plurality of hosts operate in a cluster), corresponds to restarting virtual machines (VMs) and/or other virtualized entities after failures. An HA protocol can respond to host, datastore, and/or network failures. An HA protocol can also handle VM crashes and guest operating system (OS) failures. The management platform monitors hosts in a cluster and, in the event of a failure, VMs on a failed host are restarted in other hosts of the cluster to continue operation. A VM may fail when management circuitry is unable to restart after a failure because of insufficient cluster resources.

In some examples, there may not be enough resource(s) across capable hosts in a cluster to host a failed VM. For example, if multiple hosts go down, there may not be enough hosts in the cluster to host the failed VM. Additionally, if the failed VM is limited to particular hosts (e.g., hosts with particular characteristic(s)/resource(s) and/or capable of performing particular protocols) and such particular hosts are unavailable, the management platform may be unable to restart a failed VM until a new host is added to a cluster. However, adding a host may require manual intervention and additional time, resources, and cost.

Examples disclosed herein dynamically make room for a failed entity (e.g., a VM or other virtualized entity) without having to add a new host to a cluster of hosts. In this manner, a failed VM can be restarted in a cluster without the additional time, resources, and/or cost associated with adding a host to a cluster. Examples disclosed herein dynamically make room for a failed entity by reclaiming one or more resources already allocated to other entities in a cluster. Examples disclosed herein select one or more virtual machines and/or other virtualized entities implemented in host(s) of a cluster to reconfigure and/or power off. The resource(s) of previously consumed by the reconfigured and/or powered off virtual machines and/or other virtualized entities are reclaimed to the failed virtual machine and/or other virtualized entities.

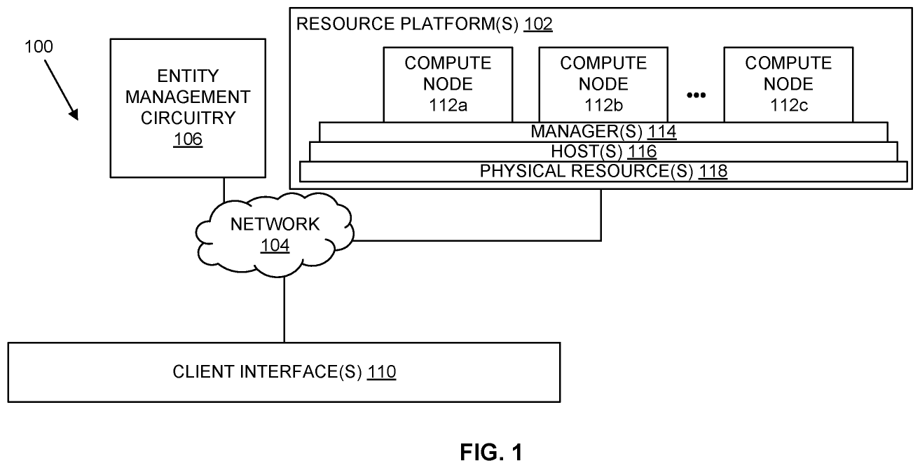

FIG. 1 is a block diagram of an example environment 100 in which example entity management circuitry 106 is configured to manage cloud accounts corresponding to example resource platform(s) 102. The example environment 100 includes the example resource platform(s) 102, an example network 104, the example entity management circuitry 106, and example client interface(s) 110. The example resource platform(s) 102 include(s) example compute nodes 112a-c, example manager(s) 114, example host(s) 116, and example physical resource(s) 118. The example computing environment 100 may be a software-defined data center (SDDC). Alternatively, the example computing environment 100 may be any type of computing resource environment such as, for example, any computing system utilizing network, storage, and/or server virtualization. Additionally, the example computing environment 100 may include any number of resource platforms, compute nodes, managers, hosts, and/or physical resources.

The example resource platform(s) 102 of FIG. 1 is a collection of computing resources that may be utilized to perform computing operations. The computing resources may include server computers, desktop computers, storage resources and/or network resources. Additionally or alternatively, the computing resources may include devices such as, for example, electrically controllable devices, processor controllable devices, network devices, storage devices, Internet of Things devices, or any device that can be managed by a resource manager. In some examples, the resource platform(s) 102 includes computing resources of a computing environment(s) such as, for example, a cloud computing environment. In other examples, the resource platform(s) 102 may include any combination of software resources and hardware resources. The example resource platform(s) 102 is virtualized and supports integration of virtual computing resources with hardware resources. In some examples, multiple and/or separate resource platforms 102 may be used for development, testing, staging, and/or production. The example resource platform 102 includes example compute nodes 112a-c, an example manager(s) 114, an example host(s) 116, and an example physical resource(s) 118.

The example compute nodes 112a-c are computing resources that may execute operations within the example computing environment 100. The example compute nodes 112a-c are illustrated as virtual computing resources managed by the example manager 114 (e.g., a hypervisor) executing within the example host 116 (e.g., an operating system) on the example physical resources 118. The example computing nodes 112a-c may, alternatively, be any combination of physical and virtual computing resources. For example, the compute nodes 112a-c may be any combination of virtual machines, containers, and physical computing resources.

Virtual machines operate with their own guest operating system on a host (e.g., the example host 116) using resources of the host virtualized by virtualization software (e.g., a hypervisor, virtual machine monitor, etc.) (e.g., the example manager 114). Numerous virtual machines can run on a single computer or processor system in a logically separated environment (e.g., separated from one another). A virtual machine can execute instances of applications and/or programs separate from application and/or program instances executed by other virtual machines on the same computer.

In some examples, containers are virtual constructs that run on top of a host operating system (e.g., the example compute node 112a-c executing within the example host 116) without the need for a hypervisor or a separate guest operating system. Containers can provide multiple execution environments within an operating system. Like virtual machines, containers also logically separate their contents (e.g., applications and/or programs) from one another, and numerous containers can run on a single computer or processor system. In some examples, utilizing containers, a host operating system uses namespaces to isolate containers from each other to provide operating-system level segregation of applications that operate within each of the different containers. For example, the container segregation may be managed by a container manager (e.g., the example manager 114) that executes in the operating system (e.g., the example compute node 112a-c executing on the example host 116). This segregation can be viewed as a form of virtualization that isolates different groups of applications that operate in different containers. In some examples, such containers are more lightweight than virtual machines. In some examples, a container OS may execute as a guest OS in a virtual machine. The example compute nodes 112a-c may host a wide variety of different applications such as, for example, an email server, a database server, a file server, a web server, etc.

The example manager(s) 114 of FIG. 1 manages one or more of the example compute nodes 112a-c. In examples disclosed herein, the example resource platform(s) 102 may include multiple managers 114. In some examples, the example manager(s) 114 is a virtual machine manager (VMM) that instantiates virtualized hardware (e.g., virtualized storage, virtualized memory, virtualized processor(s), etc.) from underlying hardware. In other examples, the example manager(s) 114 is a container engine that enforces isolation within an operating system to isolate containers in which software is executed. As used herein, isolation means that the container engine manages a first container executing instances of applications and/or programs separate from a second (or other) container for hardware.

The example host(s) 116 of FIG. 1 is/are a native operating system(s) (OS) executing on example physical resources 118. The example host(s) 116 manages hardware of a physical machine(s). In examples disclosed herein, the example resource platform(s) 102 may include multiple hosts 116 in a cluster. In some examples, the cluster can include one or more hosts 116 from one or more resource platforms 102. In the illustrated example of FIG. 1, the example host(s) 116 execute(s) the example manager 114. In some examples, certain ones of the hosts 116 may execute certain ones of the managers 114. For example, ones of the managers 114 may be allocated or assigned to corresponding ones of the hosts 116.

The example physical resource(s) 118 of FIG. 1 is a hardware component of a physical machine(s). In some examples, the physical resource(s) 118 may be a processor, a memory, a storage, a peripheral device, etc. of the physical machine(s). In examples disclosed herein, the example resource platform(s) 102 may include one or more physical resources 118. In the illustrated example of FIG. 1, the example host(s) 116 execute(s) on the physical resource(s) 118.

The example network 104 of FIG. 1 communicatively couples computers and/or computing resources of the example computing environment 100. In the illustrated example of FIG. 1, the example network 104 is a cloud computing network that facilitates access to shared computing resources. In examples disclosed herein, information, computing resources, etc. are exchanged among the example resource platform(s) 102 and the example entity management circuitry 106 via the example network 104. The example network 104 may be a wired network, a wireless network, a local area network, a wide area network, and/or any combination of networks.

The example entity management circuitry 106 of the illustrated example of FIG. 1 manages virtualized entities (e.g., virtual machines, virtualized storage, hypervisors, virtualized servers, etc.). In some examples, the example entity management circuitry 106 automatically allocates and provisions applications and/or computing resources to end users. To that end, the example entity management circuitry 106 may include a computing resource catalog from which computing resources can be provisioned. The example entity management circuitry 106 may provide deployment environments in which an end user such as, for example, a software developer, can deploy or receive an application(s). In some examples, the example entity management circuitry 106 may be implemented using a vRealize® Automation system and/or a vSphere® platform developed and sold by VMware®, Inc. In other examples, any other suitable cloud computing platform may be used to implement the entity management circuitry 106.

The example entity management circuitry 106 of FIG. 1 may monitor (e.g., collect information about and measures performance related to) the example network 104, the example compute nodes 112a-c, the example manager(s) 114, the example host(s) 116, and/or the example physical resource(s) 118. In some examples, the example entity management circuitry 106 generates performance and/or health metrics corresponding to the example resource platform 102 and/or the example network 104 (e.g., bandwidth, throughput, latency, error rate, etc.). In some examples, the entity management circuitry 106 accesses the resource platform(s) 102 to provision computing resources and communicates with a resource manager.

A user and/or administrator may set up and/or create a cloud account (e.g., a Google® cloud platform (GCP) account, a network security virtualization platform (NSX) account, a VMware® cloud foundation (VCF) account, a vSphere® account, etc.) to connect a cloud provider and/or a private cloud so that the entity management circuitry 106 of FIG. 1 can collect data from regions of datacenters and/or to allow a user and/or administrator to deploy and/or provision cloud templates to the regions. A cloud template is a file that defines a set of resources. The cloud template may utilize tools to create server builds that can become standards for cloud applications.

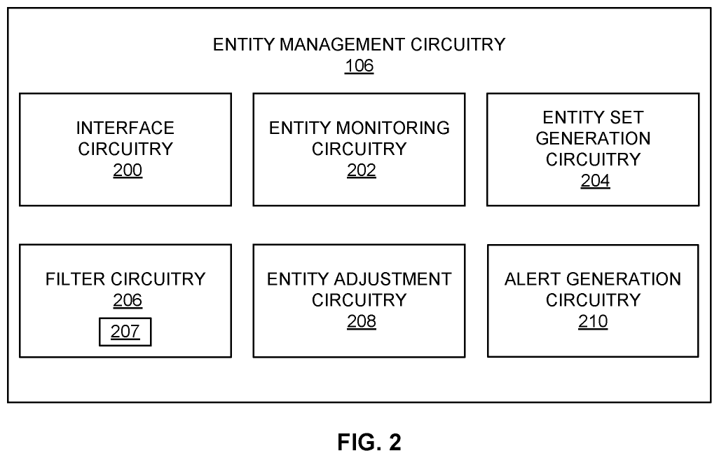

When an entity (e.g., a virtual machine) fails, the example entity management circuitry 106 of FIG. 1 identifies the failure of an entity and attempts to reclaim one or more resources from other hosts in a cluster (e.g., other hosts 116 on the resource platform 102 and/or another resource platform) that can be used to restart the failed VM to continue operation. The entity management circuitry 106 can identify a failure of an entity based on the nature of the failure. For example, the entity management circuitry 106 can detect a failed host based on lack of a signal from the failed host and/or can obtain a signal indicating that paths to a storage device is down for failed storage. In this manner, the entity management circuitry 106 can continue VM operation without adding a new host to the cluster. To reclaim one or more resources, the example entity management circuitry 106 first determines a list of entities (e.g., one or more entities) that have one or more resources that can be reclaimed. The list of entities are entities that can be powered down and/or reconfigured to reduce the amount (e.g., a number, a quantity, etc.) of resource(s) that the entity uses and reclaim those entities for the failed entity. After the example entity management circuitry 106 generates a reclamation recommendation by generating the list of entities with resource(s) that can be reclaimed, the example entity management circuitry 106 identifies a subset of entities from the list that will satisfy the resource requirements of the failed entity. In some examples, the example entity management circuitry 106 selects a minimum subset of entities to satisfy the resource requirements of the failed entity to reclaim efficiently. After the example entity management circuitry 106 selects the subset of entities from which to reclaim resource(s), the example entity management circuitry 106 implements a reclamation recommendation by reconfiguring and/or powering down the entities included in the reclamation recommendation and reclaiming the resource(s) previously used by the entities included in the reclamation recommendation to implement the failed entity. In some examples, the entity management circuitry 106 outputs the recommendation to a user and/or an administrator (e.g., via the client interface(s) 110) for acceptance prior to implementing the reclamation recommendation. The example entity management circuitry 106 is further described below in conjunction with FIG. 2.

The example client interface(s) 110 of FIG. 1 is a graphical user interface (GUI) that enables end users (e.g., administrators, software developers, etc.) to interact with the example computing environment 100. The example client interface(s) 110 enables end users to initiate compute issue(s) remediation and view graphical illustrations of compute resource performance, health metrics and/or failed entities. For example, when a VM fails, the example entity management circuitry 106 may transmit information (e.g., the reclamation recommendation and/or information related to the reclamation recommendation) to be displayed on the example client interface(s) 110 regarding the failure. The information may include reasons why the entity failed, a timestamp of the failure(s), a number of failure(s), information related to how to fix the account to avoid a failure, links to URLs that will help mitigate the failure, a status of the account (e.g., healthy, unhealthy, the current polling frequency of the account, suspended, etc.), flagged alerts, information related to how the failure was remediated, etc. In examples disclosed herein, an end user(s) may remediate cloud account issues via interactions with the example client interface(s) 110. For example, the end user(s) may update credentials associated with the cloud account using the client interface(s) 110. In some examples, the end user(s) may interact with the client interface(s) 110 to perform other operations to mitigate an entity failure. For example, an end user(s) may accept and/or deny a reclamation recommendation (e.g., using an agent that runs on an end user device to interface with server management software (e.g., vCenter® software) corresponding to the customer infrastructure of the end user drive) via the example client interface(s) 110). In some examples, another component of the system may install and execute the reclamation recommendation to resolve computing issues in the example resource platform(s) 102 and/or to perform the actions when requested by an end user. In some examples, the client interface(s) 110 may be presented on any type(s) of display device such as, for example, a touch screen, a liquid crystal display (LCD), a light emitting diode (LED), etc. In examples disclosed herein, the example computing environment 100 may include one or more client interfaces 110.

FIG. 2 is a block diagram of an example implementation of the entity management circuitry 106 of FIG. 1. The entity management circuitry 106 of FIG. 2 may be instantiated (e.g., creating an instance of, bring into being for any length of time, materialize, implement, etc.) by processor circuitry such as a central processing unit executing instructions. Additionally or alternatively, the entity management circuitry 106 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by one or more virtual machines and/or containers executing on the microprocessor. The example entity management circuitry 106 includes example interface circuitry 200, example entity monitoring circuitry 202, example entity set generation circuitry 204, example filter circuitry 206, example comparator circuitry 207, example entity adjustment circuitry 208, and example alert generation circuitry 210.

The example interface circuitry 200 of FIG. 2 obtains (e.g., accesses, receives, etc.) and or transmits (e.g., sends, outputs, etc.) data via the example network 104 (FIG. 1). For example, the interface circuitry 200 may obtain data from the resource platform(s) 102 (FIG. 1) to identify a failed entity and/or to identify one or more resources to reclaim. Additionally, the interface circuitry 200 outputs data (e.g., reclamation recommendation(s) to a device that implement the client interface(s) 110 of FIG. 1. Additionally, the interface circuitry 200 may transmit instructions to the resource platform(s) 102 to reconfigure and/or power down entities running on the resource platform(s) 102 and use the reclaimed resource(s) to implement a failed entity.

The example entity monitoring circuitry 202 of FIG. 2 monitors the health of entities (e.g., VMs), periodically, aperiodically, and/or based on a trigger (e.g., based on periodic heartbeats/signals, signals received from other systems, and/or probes). The entity monitoring circuitry 202 may attempt to access an entity (e.g., using the example interface circuitry 200). If the attempt fails (e.g., the entity could not be accessed), the example entity monitoring circuitry 202 determines that the health check has failed. If the attempt succeeds (e.g., the entity was accessed), the example entity monitoring circuitry 202 may perform one or more protocols to check the health of the cloud account. During a health check, the entity monitoring circuitry 202 checks the health of multiple entities. During the check of a single entity, the entity monitoring circuitry 202 may perform the health check for the single entity multiple times when a failure occurs. The number of retries within a signal health check is based on user and/or manufacturer preferences. If the multiple re-attempts fails, the entity monitoring circuitry 202 flags the entity as a failed entity.

The example entity set generation circuitry 204 of FIG. 2 generates a set of entities that are utilizing resource(s) that can be reclaimed for a failed entity. For example, the example entity set generation circuitry 204 first selects the entities that are in the same resource pool (e.g., executed by a host in the same cluster) as the failed entity. The example entity set generation circuitry 204 eliminates entities that do not consume resources and/or should not be included in the set. For example, the entity set generation circuitry 204 eliminates entities that are powered off from the set because entities that are powered off are not consuming resources (e.g., there are no resources that can be reclaimed from such entities). Additionally, the entity set generation circuitry 204 eliminates entities that (a) correspond to a higher priority than the failed entity, (b) are disabled for reclamation (e.g., based on user/administrator settings, characteristics of the entity, etc.), and/or (c) do not meet local resource requirement(s) (e.g., are limited to a single host and cannot move to another). The elimination of entities may be based on user and/or administrator preferences. In some examples, the entity set generation circuitry 204 breaks the set of entities into two sets of entities for reclamation based on characteristics of the entities: a reconfigure entity group and a power-off entity group. The reconfigure entity group corresponds to entities that can be reconfigured to consume fewer resources (e.g., so that the remaining resources can be reclaimed for the failed entity) relative to different configurations of entities and continue operation using the fewer resources. The power-off entity group corresponds to entities that can be powered down to consume no resources (e.g., so that the previously consumed resources can be reclaimed for the failed entity).

The example filter circuitry 206 of FIG. 2 identifies a subset of entities from the set(s) of entities generated by the entity set generation circuitry 204 that is sufficient to execute the failed entity. For example, the filter circuitry 206 iterates over the entities in the set of entities to identify a group of entities sufficient to execute the failed entity. In some examples, the filter circuitry 206 can process the reconfigure entity group first to attempt to identify the group of entities based only on the reconfigure entity group. If after processing the reconfigure entity group, the filter circuitry 206 determines that there are still not enough reclaimed resources to execute the failed entity, the filter circuitry 206 can process the power-off entity group. The order of processing and/or priority (e.g., reconfigure entity group first and power off entity group second, or vice versa) may be based on user and/or administrator preferences. In some examples, the filter circuitry 206 attempts to reclaim resource(s) based on the lowest impact (e.g., the least amount of hosts affected and/or powered down). The example filter 206 includes the example comparator circuitry 207 to make comparisons between the amount of reclaimed resources from the subgroup of and the total amount of resources needed to execute the failed entity.

The example entity adjustment circuitry 208 of FIG. 2 obtains the reclamation recommendation from the example filter circuitry 206 and adjusts (e.g., reconfigures and/or powers down) the resource platform(s) 102 based on the reclamation recommendation. For example, the entity adjustment circuitry 208 can reconfigure a first entity to cause the entity to reduce the amount of processing resources by 30% and power down a second entity. After adjusting the resource platform(s) 102 based on the reclamation recommendation, the entity adjustment circuitry 208 uses the reclaimed resource(s) to implement the failed entity. Using the example above, the entity adjustment circuitry 208 can use the 30% of the resource(s) reclaimed from the first entity and all of the resources from the second entity to implement the failed entity.

The example alert generation circuitry 210 of FIG. 2 generates alerts and transmits the alerts (e.g., via the example network 104 using the interface circuitry 200) to the client interface(s) 110 of FIG. 1. For example, the alert generation circuitry 210 may generate an alert when an entity failed, when a reclamation recommendation is generated, when a reclamation recommendation is implemented, etc. Additionally, the example alert generation circuitry 210 generates an alert when a reclamation recommendation cannot be made. For example, if the example filter 206 determines that there is not enough resource(s) from the set to execute the failed entity, the filter 206 generates an alert indicating that a reclamation recommendation cannot be made with corresponding data (e.g., how many resource(s) are needed, how many resource(s) can be reclaimed, the differences between the reclaimed resources and the resources needed, etc.).

While an example manner of implementing the entity management circuitry 106 of FIG. 1 is illustrated in FIG. 2, one or more of the elements, processes, and/or devices illustrated in FIG. 2 may be combined, divided, re-arranged, omitted, eliminated, and/or implemented in any other way. Further, the example interface circuitry 200, the example entity monitoring circuitry 202, the example entity set generation circuitry 204, the example filter circuitry 206, the example comparator circuitry 207, the example entity adjustment circuitry 208, the example alert generation circuitry 210, and/or, more generally, the entity management circuitry 106 of FIG. 2, may be implemented by hardware, software, firmware, and/or any combination of hardware, software, and/or firmware. Thus, for example, any of the example interface circuitry 200, the example entity monitoring circuitry 202, the example entity set generation circuitry 204, the example filter circuitry 206, the example comparator circuitry 207, the example entity adjustment circuitry 208, the example alert generation circuitry 210, and/or, more generally, the entity management circuitry 106 of FIG. 2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the entity management circuitry 106 of FIGS. 1-2 is/are hereby expressly defined to include a non-transitory computer readable storage device or storage disk such as a memory, a digital versatile disk (DVD), a compact disk (CD), a Blu-ray disk, etc., including the software and/or firmware. Further still, the entity management circuitry 106 of FIG. 2 may include one or more elements, processes, and/or devices in addition to, or instead of, those illustrated in FIG. 2, and/or may include more than one of any or all of the illustrated elements, processes, and devices.

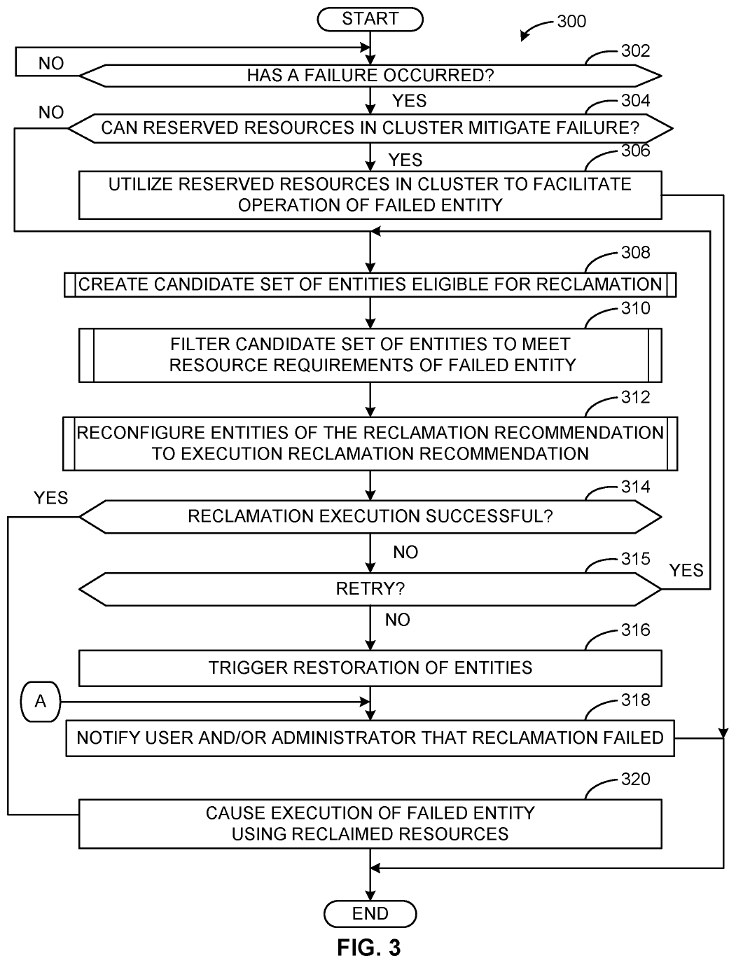

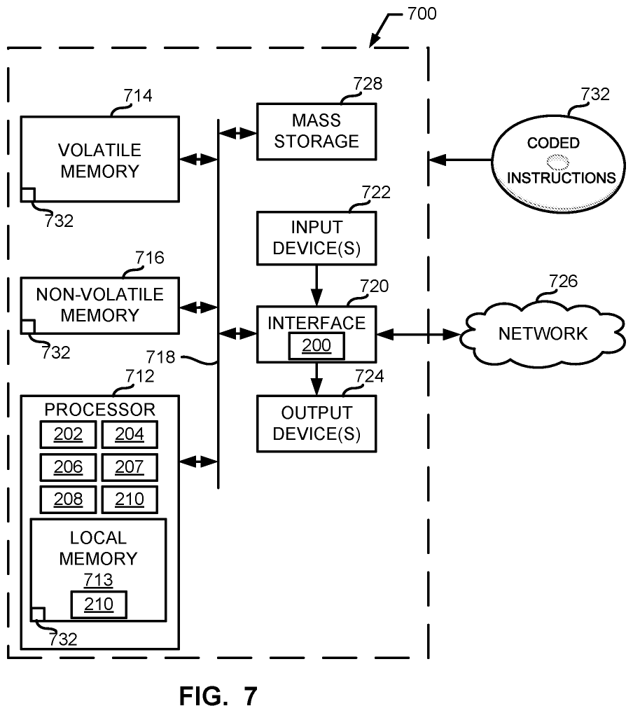

Flowcharts representative of example hardware logic circuitry, machine readable instructions, hardware implemented state machines, and/or any combination thereof for implementing the entity management circuitry 106 are shown in FIGS. 3-6. The machine readable instructions may be one or more executable programs or portion(s) of an executable program for execution by processor circuitry, such as the processor circuitry 712 shown in the example processor platform 700 discussed below in connection with FIG. 7 and/or the example processor circuitry discussed below in connection with FIG. 7. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 3-6, many other methods of implementing the entity management circuitry 106 of FIG. 2 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or compute devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a compute device and/or other machine. For example, the machine readable instructions may be stored in multiple parts, which are individually compressed, encrypted, and/or stored on separate compute devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular compute device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-6 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 illustrates a flowchart representative of example machine readable instructions and/or example operations 300 that may be executed and/or instantiated by processor circuitry (e.g., the example entity management circuitry 106 of FIGS. 1 and/or 2) to generate and/or implement a reclamation recommendation when an entity fails. Although the instructions of FIG. 3 are described in conjunction with a single failed entity, examples disclosed herein may be described in conjunction with multiple failed entities. The instructions begin at block 302 at which the example entity monitoring circuitry 202 (FIG. 2) determines that an entity has failed. For example, the entity monitoring circuitry 202 may be structured and/or programmed to perform a check of the entities in a cluster periodically, aperiodically, or based on a trigger using the example interface circuitry 200 (FIG. 2), as further described above in conjunction with FIG. 2. In such examples, the entity monitoring circuitry 202 may include and/or access a clock or timer to determine if it is time to perform a health check. In some examples, the entity monitoring circuitry 202 may attempt to restart a failed entity and determine not to proceed to block 302 until it is determined that the entity will not restart (e.g., due to a lack of resources or some other issue).

If the example entity monitoring circuitry 202 determines that an entity failure has not occurred (block 302: NO), control returns to block 302 until a failure occurs. If the example entity monitoring circuitry 202 determines that an entity failure has occurred (block 302: YES), the example entity monitoring circuitry 202 determines if the reserved resource(s) in the cluster can mitigate the failure by executing the failed entity (block 304). In some clusters, a portion of the resource(s) of each host may be reserved for failure purposes. Accordingly, if there is sufficient resource(s) in the reserve to execute the failed entity, the entity monitoring circuitry 202 can execute the failed entity using the reserved resource(s) of the host(s) in the cluster.

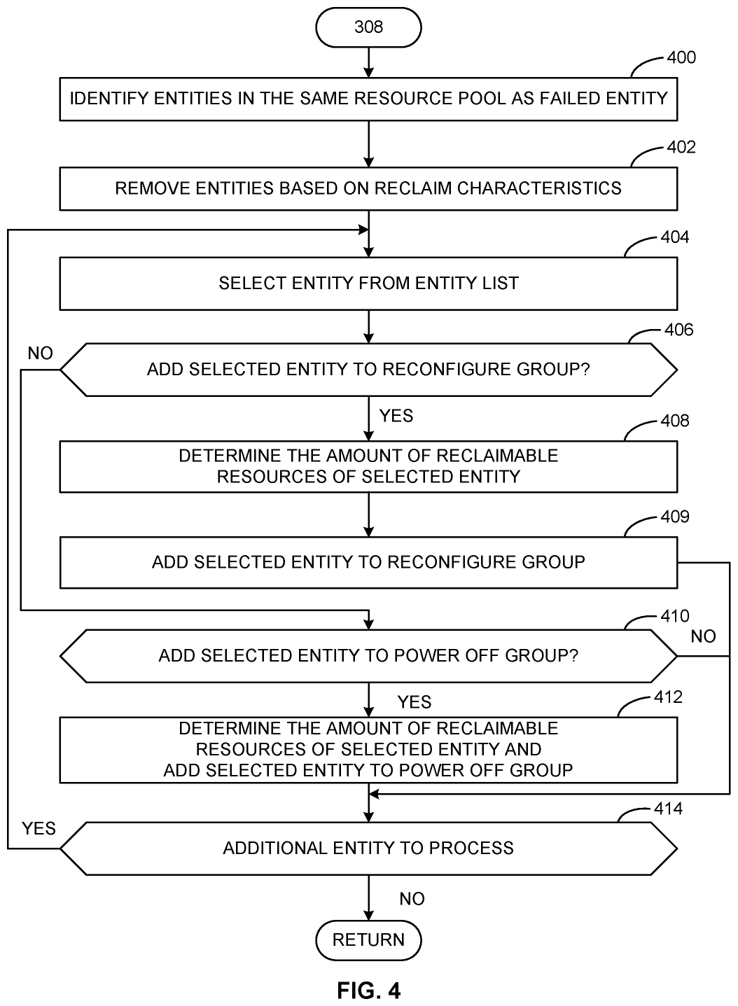

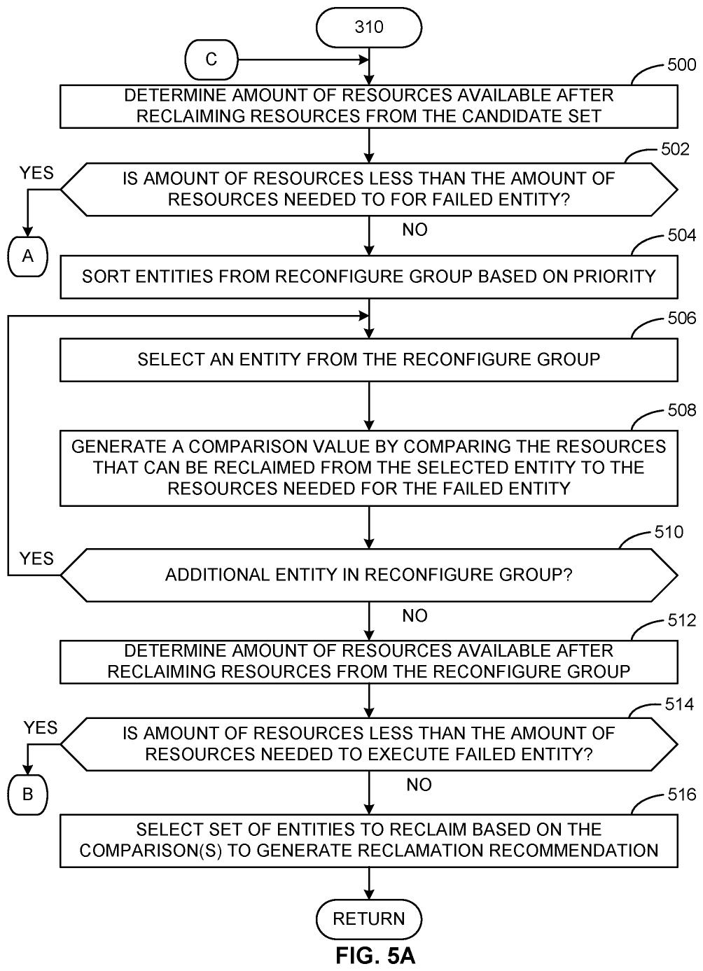

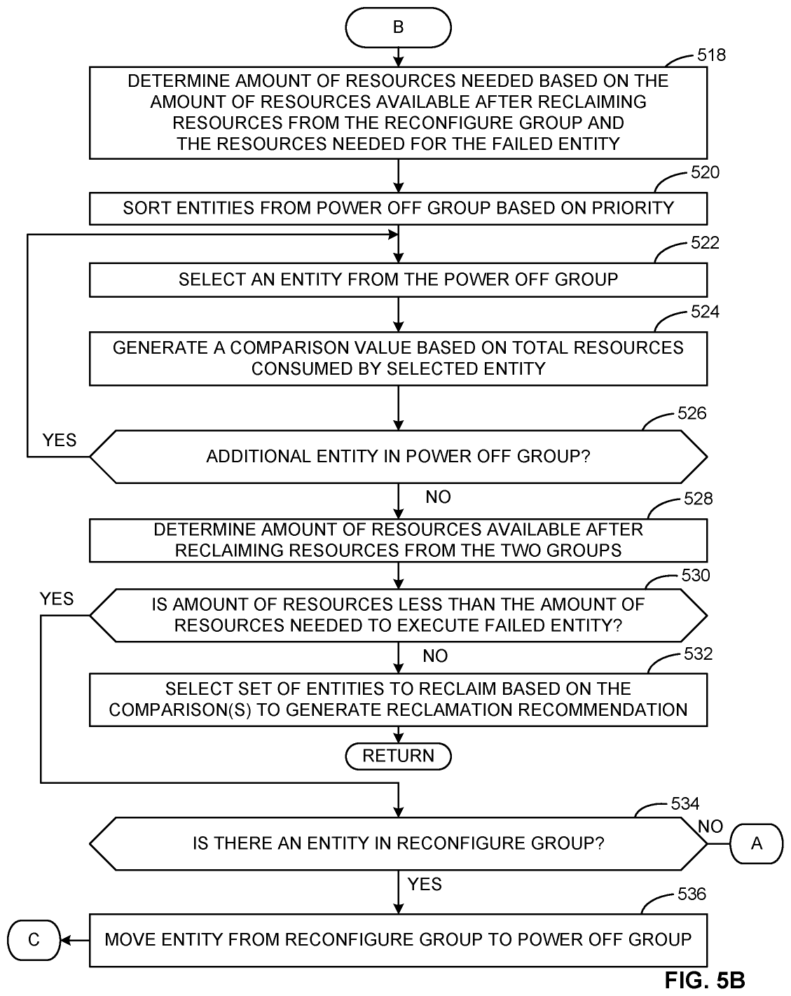

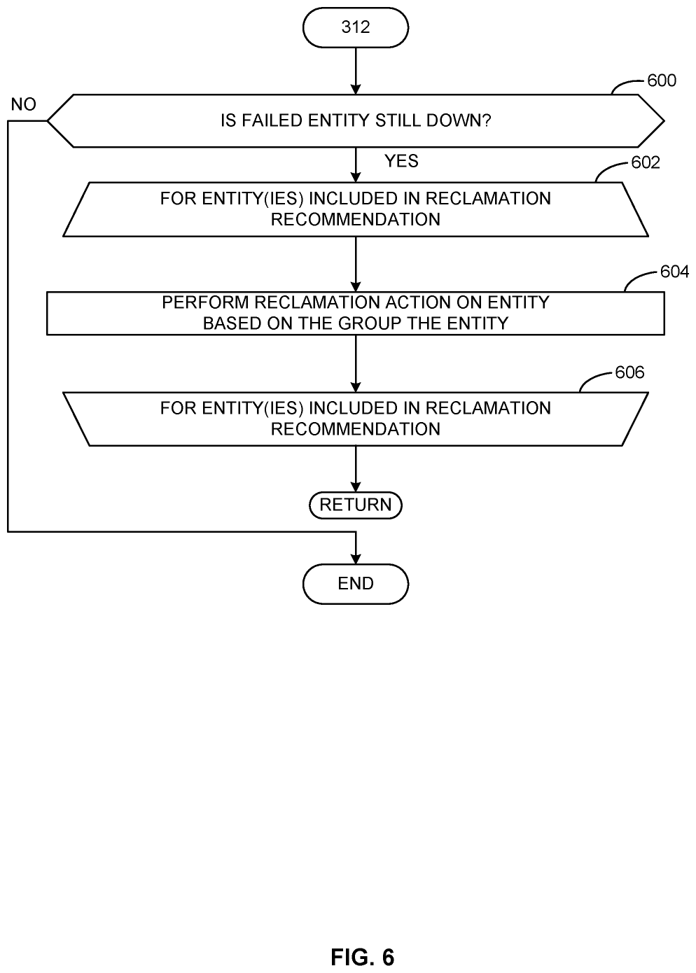

If the example entity monitoring circuitry 202 determines that the reserved resource(s) in the cluster can mitigate the failure (block 304: YES), the example entity adjustment circuitry 208 (FIG. 2) utilizes the reserved resource(s) in the cluster to facilitate operation of the failed entity (block 306) and control ends. If the example entity monitoring circuitry 202 determines that the reserved resource(s) in the cluster cannot mitigate the failure (block 304: NO), the example entity management circuitry 106 creates a candidate set of entities eligible for reclamation (block 308), as further described below in conjunction with FIG. 4. At block 310, the example entity management circuitry 106 filters the candidate set of entities to satisfy the resource requirements of the failed entity, as further described below in conjunction with FIGS. 5A and 5B. For example, the entity management circuitry 106 can filter the candidate set of entities at block 310 to generate one or more reclamation recommendations. At block 312, the example entity management circuitry 106 executes a reclamation recommendation, as further described below in conjunction with FIG. 6.

At block 314, the example alert generation circuitry 210 (FIG. 2) determines if the reclamation execution was successful. If the alert generation circuitry 210 determines that the reclamation execution was successful (block 314: YES), the example entity adjustment circuitry 208 transmits instructions (e.g., via the example network 104 of FIG. 1 using the example interface circuitry 200 of FIG. 2) to the host(s) 116 to cause the host(s) to execute the failed entity using the reclaimed resource(s) 320 (block 320). If the alert generation circuitry 210 determines that the reclamation execution was not successful (block 314: NO), the example entity adjustment circuitry 208 (FIG. 2) determines if a retry should occur (block 315). For example, the entity adjustment circuit 208 can perform a threshold number (e.g., based on user and/or manufacturer preferences) of retries before a failure occurs. If the example entity adjustment circuitry 208 determines that a retry should occur (block 315: YES), control returns to block 308. If the example entity adjustment circuitry 208 determines that a retry should occur (block 315: NO), the example entity adjustment circuitry 208 triggers restoration of the entities (block 316). For example, if during a reclamation attempt, a first entity was reconfigured or powered down and the reclamation attempt of a second entity failed, the example entity adjustment circuitry 208 will restore the prior settings of the first entity (e.g., reconfigure back to the original settings and/or power the second entity back on). In some examples, the entity management circuitry 106 does not restore the prior settings of the first entity. In such examples, the entity management circuitry 106 can use the reclaimed resource(s) to restart a portion of the failed entities. At block 318, the example alert generation circuitry 210 notify the user and/or an administrator that the reclamation failed. For example, the alert generation circuitry 210 may generate a message or alert and instruct or use the interface circuitry 200 to transmit the message or alert (e.g., via the network 104 of FIG. 1) to the client interface(s) 110. After block 318, block 206, and/or block 320, control ends.

FIG. 4 illustrates a flowchart representative of example machine readable instructions and/or example operations 308 that may be executed and/or instantiated by processor circuitry (e.g., the example entity management circuitry 106 of FIGS. 1 and/or 2) to create a candidate set of entities eligible for reclamation. The example instructions and/or operations 308 of FIG. 4 may be used to implement block 308 of FIG. 3. The instructions begin at block 400 at which the example entity set generation circuitry 204 (FIG. 2) identifies entities in the same resource pool as the failed entity (e.g., VMs that operate on hosts of the same cluster).

At block 402, the example entity set generation circuitry 204 removes entities from the identified entities based on reclaim characteristics. In this manner, the entity set generation circuitry 204 can generate an entity list based on the remaining entities. For example, the entity set generation circuitry 204 removes entities that are already powered off, that have a higher priority than the failed entity, that are disabled for reclamation, and/or that do not meet local resource requirements. At block 404, the example entity set generation circuitry 204 selects an entity from the entity list. At block 406, the example entity set generation circuitry 204 determines whether to add the selected entity to a reconfigure entity group. The example entity set generation circuitry 204 determines whether to add the selected entity to the reconfigure entity group based on a set of rules (e.g., which may be based on user, manufacturer, and/or administrator preferences). For example, the entity set generation circuitry 204 may not include entities in the reconfigure entity list that are disabled for reconfiguration (e.g., the entities may be included in the reconfigure entity list when reconfiguration is enabled). The example entity set generation circuitry 204 may include entities in the reconfigure entity list that have reclaimable CPU, memory, etc. (e.g., based on information from a managing circuitry (e.g., server management software, such as vCenter® software)). An entity has reclaimable resource(s) (e.g., CPU, memory, etc.) when the current resource utilization is less than the maximum resource(s) configured for the entity.

If the example entity set generation circuitry 204 determines that the selected entity should be added to the reconfigure entity group (block 406: YES), the example entity set generation circuitry 204 determines the amount of reclaimable resource(s) that can be obtained from the selected entity (block 408). For example, the entity set generation circuitry 204 may calculate the amount of reclaimable resource(s) (e.g., the lower and upper bounds of configurable value(s) for the resource(s) of the entity) based on a difference between the used and maximum configurable values for the resource(s) of the entity. In some examples, the entity set generation circuitry 204 adds overhead (e.g., 10% or any other user-selected percentage) to allow for an increase in resource usage by the entity. For example, if the CPU capacity of the selected entity is configured to 10 Giga hertz (GHz) and the selected entity is currently using 4 GHz, the entity set generation circuitry 204 determines that the reclaimed CPU for the entity is 5.6 GHz (e.g., 10−(4+0.1*4)=5.6). At block 409, the example entity set generation circuitry 204 adds the selected entity to the reconfigure entity group and control continues to block 414.

If the example entity set generation circuitry 204 determines that the selected entity should not be added to the reconfigure entity group (block 406: NO), the example entity set generation circuitry 204 determines if the selected entity should be added to the power off entity group (block 410). The example entity set generation circuitry 204 determines whether to add the selected entity to the power off entity group based on a set of rules (e.g., which may be based on user, manufacturer, and/or administrator preferences). For example, the entity set generation circuitry 204 may not include entities in the power off entity group if the failed entity has a dependency on the selected entity (e.g., the entity set generation circuitry 204 may include entities in the power off entity group if the failed entity is independent (or does not have a dependency) from selected entity). In some examples, all other entities may be candidates for powering off. The example filter circuitry 206 (FIG. 2) can address candidate entities based on the amount of resource(s) that can be reclaimed to minimize disruption to the cluster, as further described below. If the example entity set generation circuitry 204 determines that the selected entity should not be added to the power-off group (block 410: NO), control continues to block 414.

If the example entity set generation circuitry 204 determines that the selected entity should be added to the power-off group (block 410: YES), the example entity set generation circuitry 204 determines the amount of reclaimable resource(s) of the selected entity and adds the selected entity to the power off entity group (block 412). At block 414, the example entity set generation circuitry 204 determines if there is an additional entity to process from the entity list. If the example entity set generation circuitry 204 determines that there is an additional entity to process (block 414: YES), control returns to block 404 to process the additional entity. If the example entity set generation circuitry 204 determines that there is not an additional entity to process (block 414: NO), control returns to block 310 of FIG. 3.

FIGS. 5A and 5B illustrate a flowchart representative of example machine readable instructions and/or example operations 310 that may be executed and/or instantiated by processor circuitry (e.g., the example entity management circuitry 106 of FIGS. 1 and/or 2) to filter a candidate set of entities to meet resource requirements of failed entities to generate reclamation recommendation(s). The example instructions and/or operations 310 of FIGS. 5A and 5B may be used to implement block 310 of FIG. 3. The instructions begin at block 500 when the example entity set generation circuitry 204 (FIG. 2) determines an amount of resource(s) available after reclaiming resource(s) from the candidate set. For example, the example entity set generation circuitry 204 sums the amount of resource(s) that can be reclaimed from all the entities in the reconfigure entity list and the power-off entity list to determine the total amount of resource(s) available for reclamation.

At block 502, the example comparator circuitry 207 (FIG. 2) determines if the amount of resource(s) available for reclamation is less than the amount of resource(s) needed for the failed entity. If the example comparator circuitry 207 determines that the amount of resource(s) available for reclamation is less than the amount of resource(s) needed for the failed entity (block 502: YES), control returns to block 318 of FIG. 3 to generate an alert. If the example comparator circuitry 207 determines that the amount of resource(s) available for reclamation is not less than the amount of resource(s) needed for the failed entity (block 502: NO), the example filter circuitry 206 (FIG. 2) sorts the entities from the reconfigure entity group based on priority (block 504). The priority may be based on user, manufacturer, and/or administrator preferences. At block 506, the example filter circuitry 206 selects an entity from the reconfigure entity group. Alternatively, the example filter circuitry 206 may process the power off group entities first (corresponding to block 520-526).

At block 508, the example comparator circuitry 207 generates a comparison value by comparing the resource(s) that can be reclaimed from the selected entity to the resource(s) needed for the failed entity. In some examples, the comparator circuitry 207 may generate a cartesian coordinate for the failed entity based on the CPU required and the memory required to execute the failed entity (e.g., <CPU-required, Mem-required> as a first point) and a cartesian coordinate for the selected entity based on the CPU to be reclaimed and the memory to be reclaimed for the selected entity (e.g., <CPU-reclaimed, Mem-reclaimed> as a second point). In such examples, the comparator circuitry 207 determines the comparison value based on a Euclidean distance, or any other comparison metric, between the first point and the second point. In some examples, prior to determining the CPU, memory, etc. that can be reclaimed from the selected entity, the filter circuitry 206 determines the amount of CPU, memory, etc. that can be reclaimed (as opposed to relying on the determination of block 408 (FIG. 4)) in case the amount of resource(s) to be reclaimed has changed since the previous determination of block 408.

At block 510, the example filter circuitry 206 determines if there is an additional entity in the reconfigure entity group to process. If the example filter circuitry 206 determines that there is an additional entity in the reconfigure entity group (block 510: YES), control returns to block 506 to process the additional entity. If the example filter circuitry 206 determines that there is not an additional entity in the reconfigure entity group (block 510: NO), the example entity set generation circuitry 204 determines an amount of resource(s) available after reclaiming the resource(s) from the reconfigure entity group (block 512) by, for example adding the resource(s) that can be reclaimed due to configuration for the entities of the reconfigure entity group. At block 514, the example comparator circuitry 207 determines if the amount of resource(s) available after reclaiming resource(s) from the reconfigure entity group is less than the amount of resource(s) needed to execute the failed entity.

If the example comparator circuitry 207 determines that the amount of resource(s) is not less than the amount of resource(s) needed to execute the failed entity (block 514: NO), the example filter circuitry 206 selects a set of entities to reclaim based on the comparison(s) to generate a reclamation recommendation (block 516), and control continues to block 312 of FIG. 3. For example, the filter circuitry 206 may use a bin packing algorithm to find the set of entities, such that the vector addition of their values (e.g., the cartesian coordinates) yields the minimum distance from the value of the failed entity (e.g., <CPU-required, Mem-required>). If the example comparator circuitry 207 determines that the amount of resources is less than the amount of resource(s) needed to execute the failed entity (block 514: YES), the example entity set generation circuitry 204 determines the amount of resource(s) needed based on the amount of resource(s) available after reclaiming the resource(s) from the reconfigure entity group and the amount of resource(s) needed for the failed entity (block 518). For example, the entity set generation circuitry 204 may take a difference between the amount of resource(s) needed for the failed entity and the amount of resource(s) available after reclaiming the resource(s) from the reconfigure entity group.

At block 520, the example filter circuitry 206 sorts entities from the power off entity group based on priority. The priority may be based on user, manufacturer, and/or administrator preferences. At block 522, the example filter circuitry 206 selects an entity from the power off entity group. Although examples described herein process the reconfigure group entities first and the power off entity group second, examples disclosed herein may process the power off entity group first and the reconfigure group entities second.

At block 524, the example comparator circuitry 207 generates a comparison value based on the total resources consumed by the selected entity. For example, the comparator circuitry 207 may generate the comparison value by comparing the resource(s) that can be reclaimed from the selected entity to the resource(s) needed for the failed entity. In some examples, prior to determining the CPU, memory, etc. that are consumed from the selected entity, the filter circuitry 206 determines the amount of CPU, memory, etc. that are consumed by the second entity (as opposed to relying on the determination of block 4012 (FIG. 4)) in case the amount of consumed by the selected entity has changed since the previous determination of block 412.

At block 526, the example filter circuitry 206 determines if there is an additional entity in the power off entity group to process. If the example filter circuitry 206 determines that there is an additional entity in the power off entity group (block 526: YES), control returns to block 522 to process the additional entity. If the example filter circuitry 206 determines that there is not an additional entity in the power off entity group (block 526: NO), the example entity set generation circuitry 204 determines an amount of resource(s) available after reclaiming the resource(s) from the reconfigure group and the power off group (block 528) by, for example, adding the total resource(s) that can be reclaimed due to configuration for the entities of the reconfigure entity group and the total resource(s) consumed by the power off group entities.

At block 530, the example comparator circuitry 207 determines if the amount of resource(s) that can be reclaimed from the two groups is less than the amount of resource(s) needed to execute the failed entity. If the example comparator 207 determines that the amount of resource(s) that can be reclaimed from the two groups is not less than the amount of resource(s) needed to execute the failed entity (block 530: NO), the example filter circuitry 206 selects the set of entities to reclaim based on the comparison(s) to generate the reclamation recommendation (block 532), and control returns to block 312 of FIG. 3. For example, the filter circuitry 206 may use a bin packing algorithm to find the set of entities, such that the vector addition of their values (e.g., the cartesian coordinates) yields the minimum distance from the value of the failed entity (e.g., <CPU-required, Mem-required>).

If the example comparator 207 determines that the amount of resource(s) that can be reclaimed from the two groups is less than the amount of resource(s) needed to execute the failed entity (block 530: YES), the example filter circuitry 206 determines if there is an entity in the reconfigure entity group (block 534). If the filter circuitry 206 determines that there is an entity in the reconfigure entity group (block 534: YES), the example filter circuitry 206 moves the entity from the reconfigure entity group to the power off entity group (block 536), and control returns to block 500 to attempt to obtain more resource(s) for reclamation. If the filter circuitry 206 determines that there is not an entity in the reconfigure entity group (block 534: NO), control returns to block 318 of FIG. 3 to generate a message and/or alert.

FIG. 6 illustrates is a flowchart representative of example machine readable instructions and/or example operations 312 that may be executed and/or instantiated by processor circuitry (e.g., the example entity management circuitry 106 of FIGS. 1 and/or 2) to execute a reclamation recommendation. The example instructions and/or operations 312 of FIG. 6 may be used to implement block 312 of FIG. 3. The instructions begin at block 600 at which the example entity adjustment circuitry 208 (FIG. 2) determines if the failed entity is still down.

If the example entity adjustment circuitry 208 determines that the failed entity is not still down (block 600: NO), the process ends because the failed entity is now up and running. If the example entity adjustment circuitry 208 determines that the failed entity is still down (block 600: YES), control continues to block 602. For the entity(ies) included in the reclamation recommendation (blocks 602-606), the example entity adjustment circuitry 208 performs a reclamation action on an entity. For example, if the reclamation recommendation identifies an entity to reconfigure, the entity adjustment circuitry 208 adjusts the entity to reduce the maximum amount of resource(s) that the entity can consume based on the reclamation recommendation. In some examples, the adjustment circuitry 208 may instruct the entity and/or corresponding host to restart after the reconfiguration. If the reclamation recommendation identifies an entity to power off, the adjustment circuitry 208 transmits instructions to the entity and/or corresponding host to power off the entity. In this manner, the reclaimed resource(s) can be used to implement the failed entity. After block 606, control returns to block 314 of FIG. 3.

FIG. 7 is a block diagram of an example processor platform 700 structured to execute and/or instantiate the machine readable instructions and/or operations of FIGS. 3-6 to implement the entity management circuitry 106 of FIG. 2. The processor platform 700 can be, for example, a server, a personal computer, a workstation, a self-learning machine (e.g., a neural network), a mobile device (e.g., a cell phone, a smart phone, a tablet such as an iPad™), an Internet appliance, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements the example entity monitoring circuitry 202, the example entity set generation circuitry 204, the example filter circuitry 206, the example comparator circuitry 207, the example entity adjustment circuitry 208, and the example alert generation circuitry 210 of FIG. 2

The processor circuitry 712 of the illustrated example includes a local memory 713 (e.g., a cache, registers, etc.). In the example of FIG. 7, the example local memory 713 implements the example storage 210. Access to the main memory 714, 716 of the illustrated example is controlled by a memory controller 717. The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. The example interface circuitry 720 may implement the example interface circuitry 200 of FIG. 2.

In the illustrated example, one or more input devices 722 are connected to the interface circuitry 720. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output devices 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 732, which may be implemented by the machine readable instructions of FIGS. 3-6, may be stored in the mass storage device 728, in the volatile memory 714, in the non-volatile memory 716, and/or on a removable non-transitory computer readable storage medium such as a CD or DVD.

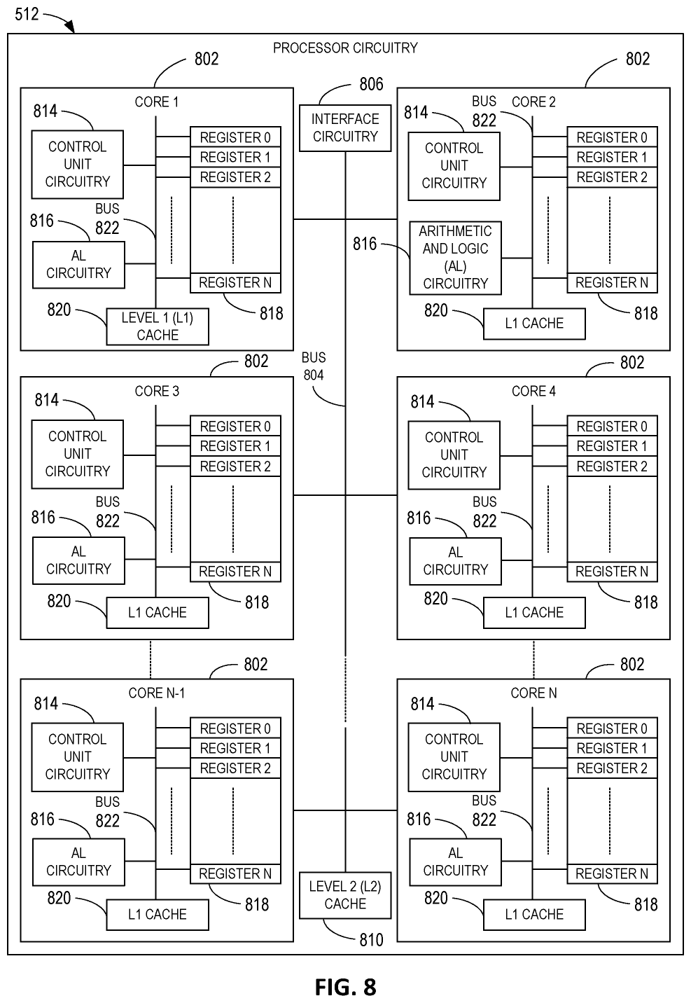

FIG. 8 is a block diagram of an example implementation of the processor circuitry 712 of FIG. 7. In this example, the processor circuitry 712 of FIG. 7 is implemented by a microprocessor 712. For example, the microprocessor 800 may implement multi-core hardware circuitry such as a CPU, a DSP, a GPU, an XPU, etc. Although it may include any number of example cores 802 (e.g., 1 core), the microprocessor 712 of this example is a multi-core semiconductor device including N cores. The cores 802 of the microprocessor 712 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowchart of FIG. 3-5.

The cores 802 may communicate by an example bus 804. In some examples, the bus 804 may implement a communication bus to effectuate communication associated with one(s) of the cores 802. For example, the bus 804 may implement at least one of an Inter-Integrated Circuit (I2C) bus, a Serial Peripheral Interface (SPI) bus, a PCI bus, or a PCIe bus. Additionally or alternatively, the bus 804 may implement any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 712 also includes example shared memory 810 that may be shared by the cores (e.g., Level 2 (L2_cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814 (e.g., control circuitry), arithmetic, and logic (AL) circuitry (sometimes referred to as an ALU) 816, a plurality of registers 818, the L1 cache 820, and an example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The bus 822 may implement at least one of an I2C bus, a SPI bus, a PCI bus, or a PCIe bus.

Each core 802 and/or, more generally, the microprocessor 712 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 712 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

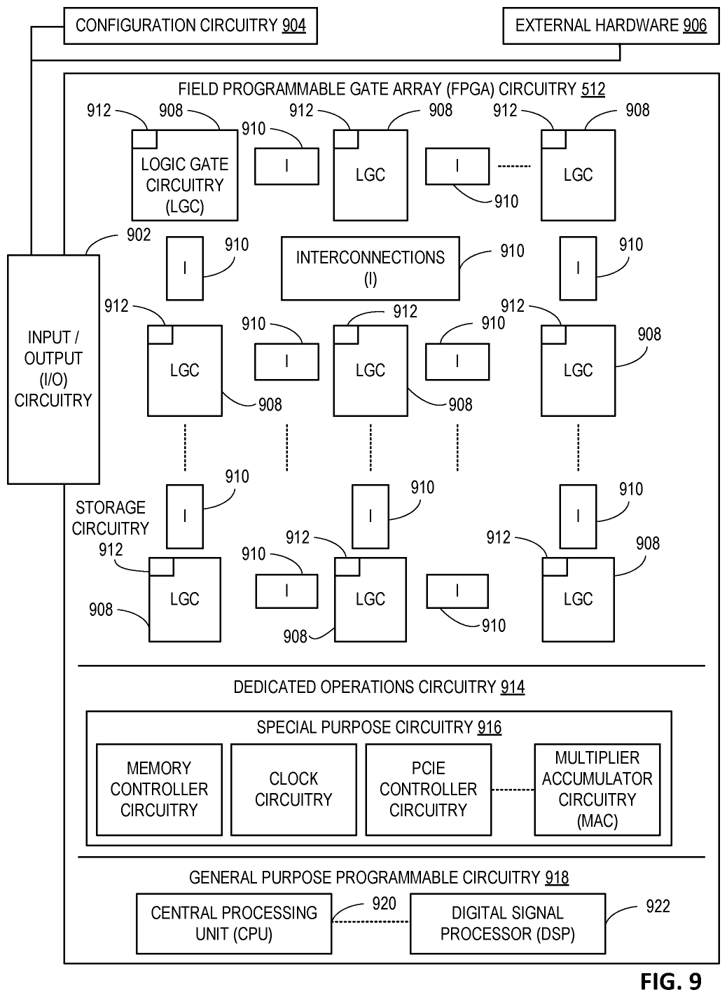

FIG. 9 is a block diagram of another example implementation of the processor circuitry 712 of FIG. 7. In this example, the processor circuitry 712 is implemented by FPGA circuitry 712. The FPGA circuitry 712 can be used, for example, to perform operations that could otherwise be performed by the example microprocessor 712 of FIG. 8 executing corresponding machine readable instructions. However, once configured, the FPGA circuitry 712 instantiates the machine readable instructions in hardware and, thus, can often execute the operations faster than they could be performed by a general purpose microprocessor executing the corresponding software.

More specifically, in contrast to the microprocessor 712 of FIG. 8 described above (which is a general purpose device that may be programmed to execute some or all of the machine readable instructions represented by the flowchart of FIGS. 3-6 but whose interconnections and logic circuitry are fixed once fabricated), the FPGA circuitry 712 of the example of FIG. 9 includes interconnections and logic circuitry that may be configured and/or interconnected in different ways after fabrication to instantiate, for example, some or all of the machine readable instructions represented by the flowchart of FIGS. 3-6. In particular, the FPGA 712 may be thought of as an array of logic gates, interconnections, and switches. The switches can be programmed to change how the logic gates are interconnected by the interconnections, effectively forming one or more dedicated logic circuits (unless and until the FPGA circuitry 712 is reprogrammed). The configured logic circuits enable the logic gates to cooperate in different ways to perform different operations on data received by input circuitry. Those operations may correspond to some or all of the software represented by the flowchart of FIGS. 3-6. As such, the FPGA circuitry 712 may be structured to effectively instantiate some or all of the machine readable instructions of the flowchart of FIGS. 3-6 as dedicated logic circuits to perform the operations corresponding to those software instructions in a dedicated manner analogous to an ASIC. Therefore, the FPGA circuitry 712 may perform the operations corresponding to the some or all of the machine readable instructions of FIG. 9 faster than the general purpose microprocessor can execute the same.

In the example of FIG. 9, the FPGA circuitry 712 is structured to be programmed (and/or reprogrammed one or more times) by an end user by a hardware description language (HDL) such as Verilog. The FPGA circuitry 712 of FIG. 9, includes example input/output (I/O) circuitry 902 to obtain and/or output data to/from example configuration circuitry 904 and/or external hardware (e.g., external hardware circuitry) 906. For example, the configuration circuitry 904 may implement interface circuitry that may obtain machine readable instructions to configure the FPGA circuitry 712, or portion(s) thereof. In some such examples, the configuration circuitry 904 may obtain the machine readable instructions from a user, a machine (e.g., hardware circuitry (e.g., programmed, or dedicated circuitry) that may implement an Artificial Intelligence/Machine Learning (AI/ML) model to generate the instructions), etc. In some examples, the external hardware 906 may implement the microprocessor 712 of FIG. 8. The FPGA circuitry 712 also includes an array of example logic gate circuitry 908, a plurality of example configurable interconnections 910, and example storage circuitry 912. The logic gate circuitry 908 and interconnections 910 are configurable to instantiate one or more operations that may correspond to at least some of the machine readable instructions of FIGS. 3-6 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 712 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry,

PCIe controller circuitry, clock circuitry, transceiver circuitry, memory, and multiplier-accumulator circuitry. Other types of special purpose circuitry may be present. In some examples, the FPGA circuitry 712 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the processor circuitry 712 of FIG. 7, many other approaches are contemplated. For example, as mentioned above, modern FPGA circuitry may include an on-board CPU, such as one or more of the example CPU 920 of FIG. 9. Therefore, the processor circuitry 712 of FIG. 7 may additionally be implemented by combining the example microprocessor 712 of FIG. 8 and the example FPGA circuitry 712 of FIG. 9. In some such hybrid examples, a first portion of the machine readable instructions represented by the flowchart of FIGS. 3-6 may be executed by one or more of the cores 802 of FIG. 8 and a second portion of the machine readable instructions represented by the flowchart of FIGS. 3-6 may be executed by the FPGA circuitry 712 of FIG. 9.

In some examples, the processor circuitry 712 of FIG. 7 may be in one or more packages. For example, the processor circuitry 712 of FIG. 8 and/or the FPGA circuitry 712 of FIG. 9 may be in one or more packages. In some examples, an XPU may be implemented by the processor circuitry 712 of FIG. 7, which may be in one or more packages. For example, the XPU may include a CPU in one package, a DSP in another package, a GPU in yet another package, and an FPGA in still yet another package.

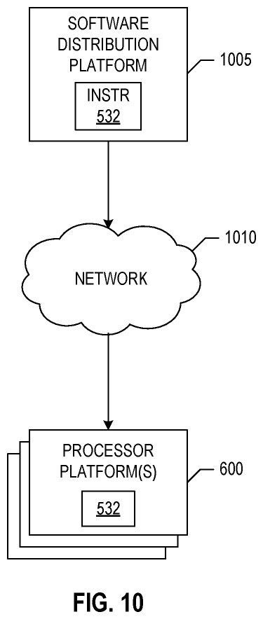

A block diagram illustrating an example software distribution platform 1005 to distribute software such as the example machine readable instructions 732 of FIG. 7 to hardware devices owned and/or operated by third parties is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions 300, 308, 310, 312 of FIGS. 3-5, as described above. The one or more servers of the example software distribution platform 1005 are in communication with a network 1010, which may correspond to any one or more of the Internet and/or any example network. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions 300, 308, 310, 312 of FIGS. 3-6, may be downloaded to the example processor platform 700, which is to execute the machine readable instructions 732 to implement the entity management circuitry 106. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices.

From the foregoing, it will be appreciated that example systems, methods, apparatus, and articles of manufacture have been disclosed that improve availability of failed entities. Examples disclosed herein reclaim resource(s) consumed by virtualized entities to implement a failed entity without adding a host to a cluster of hosts that implement the virtualized entities. In this manner, a failed entity can be restarted in a cluster without the additional time, resource(s), and/or cost associated with adding a host to a cluster. Thus, disclosed systems, methods, apparatus, and articles of manufacture are accordingly directed to one or more improvement(s) in the operation of a machine such as a computer or other electronic and/or mechanical device.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A system to reclaim for a failed entity, the system comprising:
memory;
computer readable instructions; and
programmable circuitry to be programmed by the computer readable instructions to:
generate a reclamation recommendation based on a subset of entities eligible for reclamation, the subset of the entities meeting a resource requirement of a failed entity;
reconfigure the subset of the entities to reclaim one or more resources of the subset of the entities based on the reclamation recommendation; and
execute the failed entity using the reclaimed one or more resources of the subset of the entities.

2. The system of claim 1, wherein the programmable circuitry is to select the entities eligible for reclamation by:
identifying the entities in a same resource pool as the failed entity; and
grouping the entities into a first group or a second group, the first group corresponding to reconfiguration and the second group corresponding to powering off.

3. The system of claim 2, wherein the programmable circuitry is to group a first entity of the entities in the first group when at least one of (a) the first entity utilizes less resources than a maximum amount of resources configured for the first entity, (b) reconfiguration is enabled for the first entity, or (c) the first entity corresponds to reconfigurable resources.

4. The system of claim 2, wherein the programmable circuitry is to group a first entity of the entities in the second group when the first entity is not included in the first group and the failed entity is independent from the first entity.

5. The system of claim 1, wherein the programmable circuitry is to generate the reclamation recommendation by:
determining a quantity of the one or more resources that can be reclaimed from ones of the entities;
generating comparison values based on differences between the quantity of the one or more resources that can be reclaimed from the entities and the quantity of the one or more resources needed for the failed entity; and
selecting the ones of the entities based on the comparison values.

6. The system of claim 5, wherein the programmable circuitry is to select the ones of the entities using a bin packing algorithm.

7. The system of claim 1, wherein the programmable circuitry is to reconfigure the subset of the entities to reclaim the one or more resources of the subset of the entities by at least one of powering down at least one entity in the entities or reconfiguring at least one entity of the entities to reduce a maximum amount of resources that the at least one entity can consume.

8. A non-transitory computer readable storage medium comprising instructions to program programmable circuitry to at least:
generate a reclamation recommendation based on a subset of entities eligible for reclamation, the subset of the entities satisfying a resource requirement of a failed entity;
reconfigure the subset of the entities to reclaim one or more resources of the subset of the entities based on the reclamation recommendation; and
execute the failed entity using the reclaimed one or more resources of the subset of the entities.

9. The non-transitory computer storage readable medium of claim 8, wherein the programmable circuitry is to select the entities eligible for reclamation by:
selecting the entities in a same resource pool as the failed entity; and
grouping the entities into a first group or a second group, the first group corresponding to reconfiguration and the second group corresponding to powering off.

10. The non-transitory computer storage readable medium of claim 9, wherein the programmable circuitry is to group a first entity of the entities in the first group when at least one of (a) the first entity utilizes less resources than a maximum amount resources configured for the first entity, (b) reconfiguration is enabled for the first entity, or (c) the first entity corresponds to reconfigurable resources.

11. The non-transitory computer storage readable medium of claim 9, wherein the programmable circuitry is to group a first entity of the entities in the second group when the first entity is not included in the first group and the failed entity is independent from the first entity.

12. The non-transitory computer storage readable medium of claim 8, wherein the programmable circuitry is to generate the reclamation recommendation by:
determining an amount of the one or more resources that can be reclaimed from ones of the entities;
generating comparison values based on differences between the amount of the one or more resources that can be reclaimed from the entities and the amount of the one or more resources needed for the failed entity; and
selecting the ones of the entities based on the comparison values.

13. The non-transitory computer storage readable medium of claim 12, wherein the programmable circuitry is to select the ones of the entities using a bin packing algorithm.

14. The non-transitory computer storage readable medium of claim 8, wherein the programmable circuitry is to reconfigure the subset of the entities to reclaim the one or more resources of the subset of the entities by at least one of powering down at least one entity in the entities or reconfiguring at least one entity of the entities to reduce a maximum amount of resources that the at least one entity can consume.

15. A method to reclaim resources for a failed entity, the method comprising:
generating, by executing an instruction with processor circuitry, a reclamation recommendation based on a subset of entities eligible for reclamation, the subset of the entities meeting a resource requirement of a failed entity;
reconfiguring, by executing an instruction with the processor circuitry, the subset of the entities to reclaim a resource of the subset of the entities based on the reclamation recommendation; and
executing, by executing an instruction with the processor circuitry, the failed entity using the reclaimed resource of the subset of the entities.

16. The method of claim 15, wherein selecting of the entities eligible for reclamation includes:
identifying the entities in a same resource pool as the failed entity; and
grouping the entities into a first group or a second group, the first group corresponding to reconfiguration and the second group corresponding to powering off.

17. The method of claim 16, further including grouping a first entity of the entities in the first group when at least one of (a) the first entity utilizes less resources than a maximum amount of resources configured for the first entity, (b) reconfiguration is enabled for the first entity, or (c) the first entity corresponds to reconfigurable resources.

18. The method of claim 16, further including grouping a first entity of the entities in the second group when the first entity is not included in the first group and the failed entity is independent from the first entity.

19. The method of claim 15, wherein the generating of the reclamation recommendation includes:
determining a quantity of the resource that can be reclaimed from ones of the entities;
generating comparison values based on differences between the quantity of the resource that can be reclaimed from the entities and the quantity of the resource needed for the failed entity; and
selecting the ones of the entities based on the comparison values.

20. The method of claim 19, further including selecting the ones of the entities using a bin packing algorithm.

21. The method of claim 15, further including reconfiguring the subset of the entities to reclaim the resource of the subset of the entities by at least one of powering down at least one entity in the entities or reconfiguring at least one entity of the entities to reduce a maximum amount of resource that the at least one entity can consume.
